(19) United States
(12) Patent Application Publication
(10) Pub. No.: US 2012/0175468 A1
(43) Pub. Date: Jul. 12, 2012

(54) Remote Controlled Drone Aircraft to Mist and Cool Roofs

(76) Inventor: Eric Zerof, New York, NY (US)

(21) Appl. No.: 13/026,061

(22) Filed: Feb. 11, 2011

Related U.S. Application Data
(60) Provisional application No. 61/431,935, filed on Jan. 12, 2011.

(51) Int. Cl. B64C 13/20; B64C 13/18; H04N 7/18; G05D 1/00; B64D 17/80; B64D 1/16; B64D 1/18

(52) U.S. Cl. 244/190; 244/136; 244/175; 348/144; 348/E07.085

(57) ABSTRACT

A system for delivering cooling water to building roofs by means of drone aircraft is disclosed. Control systems for navigation and precisely targeting a water spray are disclosed.

### PRIORITY CLAIM

This application claim priority to and herein incorporates by reference U.S. Provisional Patent Application No. 61/431,935, filed on Jan. 12, 2011.

### SUMMARY OF THE INVENTION

Buildings in hot climates can reduce air conditioning work-load by the application of small amounts of water to the roof of the building. Water can be delivered selectively by use of a flying drone aircraft programmed to deliver water to specific buildings. The valves are controlled by electronics that detect when the aircraft has crossed the edge of the roof.

### DESCRIPTION OF THE FIGURES

1. Drone aircraft and target building.

2. Edge detection of building roof.

3. Side to Side detection of building roof.

4. Architecture of drone control system.

5. Radio beacons on building rooftop.

6. Drone with stored GPS coordinates that indicates building rooftop location.

### DETAILED DESCRIPTION OF THE PREFERRED EMBODIMENTS:

Cooling during Peak Demand. Summer sunlight raises roof surface temperatures to as high as 150 degrees Fahrenheit. Some of the heat on the roofs flows into the interior of buildings and adds to the air conditioning cooling load. By directly cooling the roof, one can reduce electric demand when it is often at its highest. There is a need for targeted cooling of building roofs.

Typical approaches to save cooling energy are costly on a per building basis—Photovoltaic (solar energy) panels directly convert some of the solar radiation into electricity; but installation is capital and labor intensive.

Cool roof coatings—are also capital and labor intensive and may not be appropriate for existing structures.

Insulation—properly insulating existing structures also significantly reduces the amount of heat flow from the roof to the interior of buildings; this is somewhat more labor intensive. But the technologies should be seen as complimentary—drone misting will still have some value for well insulated structures.

Permanent misting systems—These are cost effective only for factory sized structures.

This invention involves dispatching remote controlled drone aircraft from central locations. The aircraft will fly over buildings and spray (or mist) small amounts of water. This will cool the roofs of target structures sufficiently to save cooling energy.

Water requirements—As little as half a cup of water per square foot per day can reduce a building's cooling load. This is less water than a roof receives from a night's heavy dew, and works out to approximately 8 gallons per person per day.

Drone features—In one embodiment, the drones will be powered with electric motors. They will be designed so that technicians can pre-program their routes in order to avoid obstacles. Cameras, sensors and radios will be added for adjustments and monitoring. Safety features will be necessary, such as infra-red sensing devices to minimize likelihood of crashing into persons, parachute for flight failure,.

Drone Design Considerations—The drone will need to be large—at least 100 pounds (mostly water) to enable it to efficiently mist twenty-five or so average sized houses (1000 square feet of roof) a day.

Drone safety—the drones will operate slowly and at a relatively safe low altitude; still designing it to avoid people and structures is important.

Dispatch areas—Some structures are needed for shelter, fueling (electricity) and water. Right of way should provide appropriate locations.

Typical use of the invention is to reduce electric demand when electricity is most expensive (times of peak demand). Average summertime price per electricity kwh is about 25 cents/kwh but is volatile. The drones will be most effective at reducing costs on older, black roofed buildings.

Water use—8 gallons/day per person would add about 1% to the total US water consumption.

One factory installed roof cooling system is estimated to save about 750,000 kwh per year for the 250,000 square foot building. (3 kwh per square foot per year)

Given size limitations, assuming about ¼ as much water (½ cup per square foot, per day). But if misting is timed correctly there could be ½ the savings.

So electricity saved per year, per drone would be:

3 kwh/square foot×25,000 square feet×½(load reduction)=37,000 kwh saved per drone per year.

Water cost can be reduced since there is no run off (so no sewage charges should apply). Assuming $1.50 per 1000 gallons (the average US water rate), water cost per drone would be about $1 per day, or about $100 per year.

To mist 25 houses at an average of 1000 square feet of roof with V2 cup of water per square foot per day would require the drones to deliver 6,250 cups of water a day. That's about 3,000 pounds of water. In one embodiment the drones make 20 passes over the buildings each day, which implies a load of 150 pounds each time. This will spread out the misting and allow the drones to be replenished. In this embodiment, the drone therefore is an aircraft with a water tank, a valve operatively connected to the tank and controlled by the control system, a water outlet operatively connected to the valve, one or more sensors and a control system that takes input from the sensors and drives the valve. The control system, which may be comprised of a computer with appropriate interfaces with the sensors and the valve. When the sensors send signals so that the control system detects that the drone is appropriately positioned, the control system will cause the valve to open, passing water to the outlet and thereby down onto the roof. When the prescribed amount of water has passed, which can be determined by determining a period of time, the control system closes the valve. After the valve is closed, the drone can continue on its route to the next building.

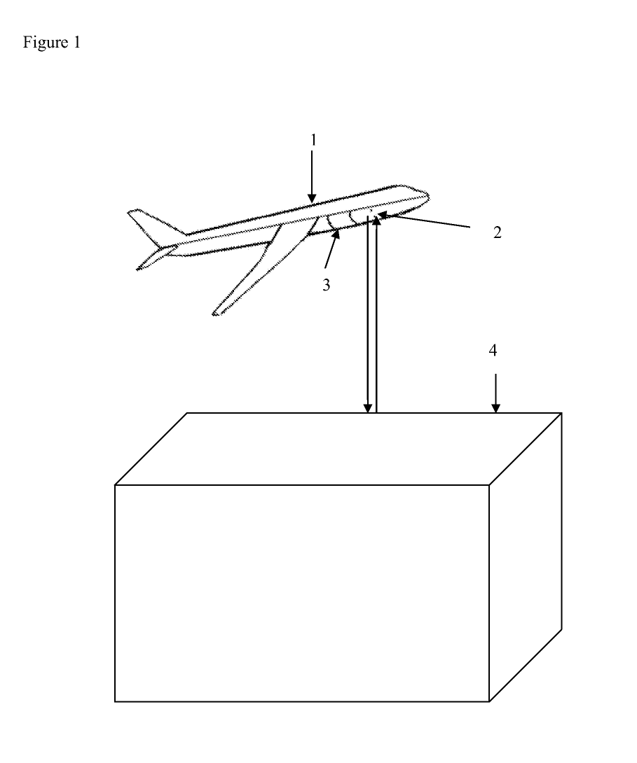

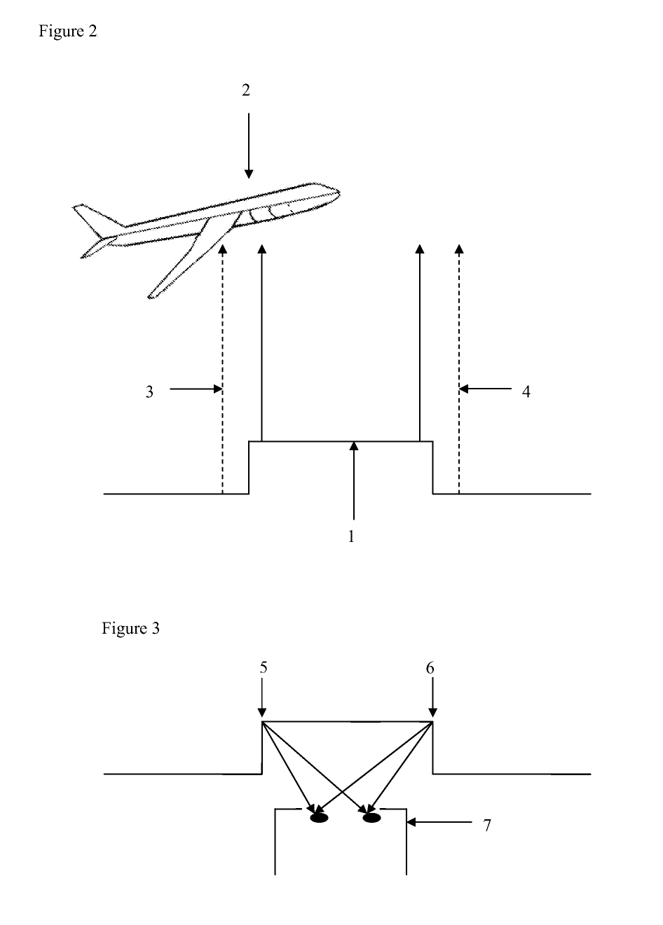

The down view sensors are used to detect the edge of a hot roof (FIG. 2). Two forward view sensors detect the left and right edge of an oncoming roof and adjust flight path to the middle (FIG. 3). Operation of the drone is depicted in FIG. 1. The drone containing the water tank, valve and control electronics flies over a pre-determined route. At a point that is approximately where the drone is to deliver water, the electronics detect the edge of a roof. This is accomplished by detecting the infrared radiation that is projecting up off the roof. When the sensors provide input to the control system that show that the infrared radiation has gone from a relatively low amount to a relatively high amount, the edge of the roof has been detected. The two thresholds are predetermined and can be adjusted, including remotely adjusted while the drone is in flight. Upon the edge being detected, the valves are opened to a predetermined flow rate to spray the water. In one embodiment, the opposing edge is detected the valve shuts off. In another embodiment, the water is shut off after a predetermined period of time. In yet another embodiment, the valve is opened after the edge is detected to minimize waste.

FIG. 1 shows the drone (1) with sensors (2) and a water tank (3). The edge of the building is shown at (4). In FIG. 2, the drone (2) detects the point where the infrared radiation (3) goes from a relatively low intensity to a high intensity. This indicates the edge of the roof (1). In one embodiment, upon detecting the reverse sequence (4) the drone's control system turns off the valve. In FIG. 3, a side view from the drone perspective is shown. In this diagram, two sensors (7) are used to detect the sides of the roof. (5), (6). By triangulation, the drone's path can be adjusted to fly over the main mass of the roof.

In another embodiment, radio frequency beacons can be placed on the roof of the building or buildings to be treated. In one embodiment, the beacons may be wi-fi (tm) antennas or bluetooth (tm) antennas. In another embodiment, these beacons are linked to a data network.

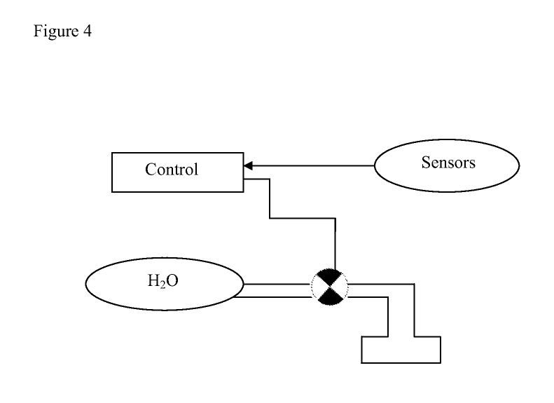

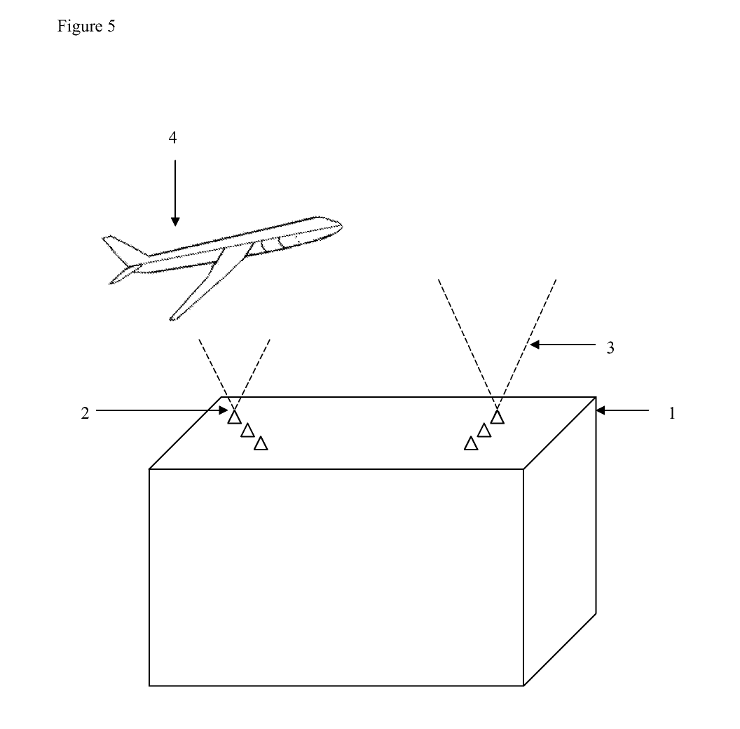

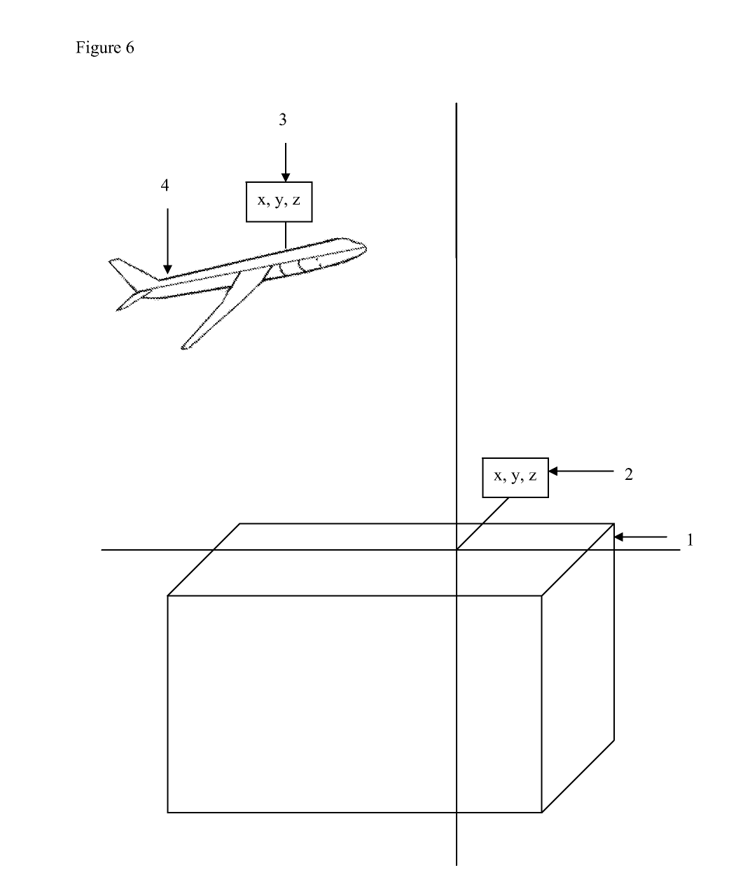

FIG. 4 shows the connection of the sensors to the control unit. The control unit controls an electrically actuated water valve. A water tank is connected to the valve to deliver the water. FIG. 5 shows radio beacons with antennas (2) on a building rooftop (1) directing signals (3) upwards to be received by a drone aircraft (4).

The radio beacons can be used by the drone to navigate to a specific building roof. By addressing the radio beacons, each beacon can appear distinct while sharing the same range of radio frequency. For example, each radio frequency beacon can transmit a signal containing a unique numerical address that corresponds to the physical location or physical address of the building.

When in operation, the drone takes off and uses GPS (Global Positioning System, tm) to navigate to a specific neighborhood of operation. At that point, the radio beacons may be used to fine tune the navigation. Alternatively, the GPS may be relied on throughout. Each building will have GPS coordinates stored in the drone controller. The controller will control the path of the drone to the building. When the drone crosses the edge of the building roof, a predetermined amount of water will be expelled onto the roof. At that point, the controller will navigate the drone to the next proximate building to be treated. FIG. 6 shows a drone (4) with GPS coordinates stored in the drone controller (3) that indicate the building rooftop's (1) location (2). In one embodiment, the GPS location of a building is mapped in a database to the emitted address associated with the beacons on the roof.

A complete system will be comprised of a plurality of drones. The drones will be comprised of a controller unit which navigates the drone and controls the release of water. The controllers will have a radio frequency transceiver that facilitates communication between a ground control system and the plurality of drones. The drones can be maintained in a small airport like facility. When requested by a subscribing building owner, a drone can be dispatched to deliver water. In that embodiment, a building owner can log into a web-site operating on a server and submit a request for service. The ground system can confirm the identity of the owner as a subscriber to the service, and then transmit the GPS coordinates of the building to the drone controller. Finally, a command to take off and navigate to the building and return is given to the selected drone.

In another embodiment, the system works automatically. The system can include one or more remote weather stations that transmit over a data network to the ground system local temperature, humidity and wind status. When the temperature, humidity and wind status of a given predetermined area are determined by a computer to meet a predetermined conditions that make it cost effective to apply water to the roofs, (based on one or more weather measurements that constitute a sufficient representative sample) then the GPS coordinates associated with subscribing customer's buildings in that predetermined area are collected from a database. The database can check that customers are up to date with payment or other credit information to determine whether the customer will be included in the next cooling flight plan. In one embodiment, a route is designed by a computer using known algorithms. In another embodiment, the algorithm is one that solves the traveling salesman problem. Once a route has been designated, it is loaded into the controller of one or more drones which are then commanded to take off and execute the route. In another embodiment, the drones are remotely piloted, in which case the ground-based pilot creates a flight plan out of the list of GPS coordinates and executes it.

Executing the route entails taking the first GPS location in the flight plan from a stack and then navigating the drone to that location. Then, the beacons may be used to precisely deliver the water. At that point, the next GPS location is selected from the stack. When the stack is empty, the drone navigates back to the ground location.

The drone aircraft can be entirely automatically piloted or piloted remotely. An example of a remote piloted aircraft is presented in U.S. Pat. No. 5,240,207 to Pedersen, which is hereby incorporated by reference for all that it teaches. An example of a remote drone control system is presented in U.S. Pat. No. 7,219,861 to Barr, which is hereby incorporated by reference for all that it teaches.

The drones may also be equipped with one or more safety systems. One system will be a human avoidance system. Another will be a loss of control system.

The human avoidance system will be comprised of a combination sensors and computer algorithms. The sensors will be forward looking visual wavelength and infrared wavelength sensors that will detect the presence of people through a combination of heat, motion, and visual recognition algorithms. The safety evaluative system may be stored in the computer memory of the drone; or it may be stored in a remote controller. If the drones are being remotely piloted the drones will notify commanding personnel of possible presence of people below the flight path. If the drones are operating automatically the software will attempt to adjust flight path to avoid flying over humans.

In one embodiment, there is a loss of control system incorporated into the drone. It is comprised of software that interacts with the drone flight control system and the drone radio communication system. It may be triggered by a loss of radio signal from remote location or by remote pilot decision. If the loss of control system is activated the drone will attempt to find a safe place to land or immediately deploy a parachute. The parachute can be deployed by the control system in the event the flight system detects that the aircraft has stalled, is in a spin or otherwise has become unstable in flight.

Practitioners of ordinary skill will recognize that the invention may be executed on one or more computer processors that are linked using a data network, including, for example, the Internet. In another embodiment, different steps of the process can be executed by one or more computers and storage devices geographically separated and connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. Data may be referenced directly or indirectly by an address, pointer or index value and thereby presented to the processing unit.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the JO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques, the overall results or otherwise departing from the true scope of the invention. The spirit and scope of the present invention are to be limited only by the terms of the appended claims.

1. A system for delivering water to building rooftops comprising:
A drone aircraft comprised of sensors operatively connected to a control system, a water tank, an electrically actuated water valve operatively connected to said tank, a water outlet operatively connected to said valve and a control system that causes the valve to open so that water is emitted from the water tank through the outlet when the control system detects by means of the sensors a predetermined relative amount of increase in infrared radiation from beneath the drone as it travels over one or more buildings.

2. The system of claim 1 further comprising a computer memory in which is stored GPS locations of at least one building.

3. The system of claim 1 further comprising a radio emitting beacon positioned on at least one building, where the control system detects the presence and relative position of the beacon.

4. The system of claim 3 where the at least one building is associated with a corresponding at least one GPS location stored in the computer memory.

5. The system of claims 1-4 where the drone aircraft is automatically piloted.

6. The system of claims 1-4 where the drone aircraft is remotely piloted.

7. A method of cooling a building comprising:
Receiving at least one weather measurement associated with a predetermined geographic area;
Determining using a computer whether the measurement meets a predetermined threshold condition;
In response to meeting the predetermined threshold condition, searching a database to determine the GPS locations of a set of predetermined buildings located in the predetermined geographic area;
Causing a drone aircraft comprised of a water tank to fly over the set of predetermined buildings and spray a predetermined amount of water on the roofs of said buildings.

8. The method of claim 7 further comprising:
Receiving a radio signal from a building, said signal encoding digital data representing an identifier;
Confirming that said identifier is associated with one of the set of buildings; and
Using the radio signal to fine tune the navigation of the drone.

9. The method of claim 7 further comprising:
Detecting that the flight of the drone is unstable; and
Deploying a parachute to land the drone in response to the detection step.

10. The method of claim 7 further comprising:
Receiving a request for a building to be included among the set of predetermined buildings;
Updating the list of the set of predetermined buildings.

11. The method of claim 7 further comprising:
Detecting the presence of people under the intended drone flight path; and
Adjusting the intended drone flight path so as not to fly over people.

12. The system of claim 1 further comprising a computer comprised of a computer memory containing data representing the intended flight route for the drone.

13. The system of claim 12 where the route data is comprised of at least one GPS coordinate corresponding to at least one building roof.

13. The system of claim 12 where the route data is comprised of data embodying identifiers unique to at least one building.

14. The system of claim 1 further comprising a parachute.

15. The method of claim 1 further comprising a video camera operatively connected to a computer operating a visual recognition program in order to detect the presence of people under the drone aircraft.
